(19) United States
(12) Patent Application Publication
(10) Pub. No.: US 2015/0046309 A1
(43) Pub. Date: Feb. 12, 2015

(54) COMMODITY CURVES BASED ON DERIVATIVE CONTRACT SPECIFICATIONS

(71) Applicants: Andy Peichl, Ubstadt-Weiher (DE); Ingo Siebeking, Heidelberg (DE); Jelena Wevelsiep-Djokic, Karlsruhe (DE); Santo Bianchino, Schifferstadt (DE); Manfred Crumbach, Wiesloch (DE); Klaus Mueller, Neustadt (DE); Claudia Volke, Ostringen (DE); Sacha Droste, Wiesloch (DE)

(72) Inventors: Andy Peichl, Ubstadt-Weiher (DE); Ingo Siebeking, Heidelberg (DE); Jelena Wevelsiep-Djokic, Karlsruhe (DE); Santo Bianchino, Schifferstadt (DE); Manfred Crumbach, Wiesloch (DE); Klaus Mueller, Neustadt (DE); Claudia Volke, Ostringen (DE); Sacha Droste, Wiesloch (DE)

(73) Assignee: SAP AG, WALLDORF (DE)

(21) Appl. No.: 14/030,767

(22) Filed: Sep. 18, 2013

Related U.S. Application Data
(60) Provisional application No. 61/863,623, filed on Aug. 8, 2013.

(51) Int. Cl. G06Q 40/04

(52) U.S. Cl. CPC G06Q 40/04
USPC 705/37

(57) ABSTRACT

A system receives a commodity identification, a curve type, and a curve category. The system also receives an interpolation identification, an extrapolation identification, a read procedure, and a maximum number of days for a readback. The system further receives contract data, the contract data including a market identifier code, a derivative contract specification (DCS) identification, and a price type. The system uses the contract data to generate a commodity curve based on DCS, and displays the commodity curve based on DCS on an electronic display unit.

### RELATED APPLICATION

This application claims priority to U.S. Serial Application No. 61/863,623, filed on Aug. 8, 2013, which is incorporated herein by reference in its entirety.

### TECHNICAL FIELD

The current disclosure relates to a system for the generation of commodity curves based on a Derivative Contract Specification (DCS).

### BACKGROUND

No person knows what commodity prices will be agreed to and paid for in the future, e.g. tomorrow or next month. However, prices paid today or in the past for a future delivery date or period (such prices are called forward prices) are readily observable and known. Commodity curves are built based on these price data.

Since a market price cannot be provided for every future delivery date by market data providers or exchanges, interpolations between given forward prices are required to derive actual prices for such dates where no quotation is given. By this interpolation, a commodity forward curve is constructed. Such a curve is required within different contexts and for a lot of calculations. These may be for legal requirements (e.g., period end valuations), for risk management activities (e.g., market to market reporting), for provisional pricing for physical deliveries with price quotation periods still in the future, or for any other task requiring market prices for future delivery. The observed market prices may actually be prices from individual purchase and sales contracts, or prices from financial contracts (derivatives) on commodities.

One important class of such contracts are exchange traded contracts called commodity futures. Interpolation and extrapolation are used to form commodity curves out of such observed market data. More precisely, the commodity curve can be defined as follows. A commodity curve is a commodity price function defined on a time interval and based on prices for forward delivery (observed in the commodity market) at a specific historical or actual point in time. In short, commodity curves are used to calculate forward prices for a selected commodity that is valid at a certain date. More specifically, a commodity curve is always defined on a particular date that is commonly referred to as the curve date. A curve date is normally either a system date or some date from the past. A curve date is not set in the future, since the prices for financial derivatives are unknown for any future time point.

A commodity curve is graphically presented in a two dimensional coordinate system. The y-axis is a price displayed in a given currency (“curve currency”). The x-axis represents the commodity derivatives sorted in an ascending order from the curve date to the time infinity (e.g., defined by Dec. 31, 9999). Since commodity derivatives are defined by some abstract security ID (e.g., “PITCA_NOV 12”), attached to the commodity derivative is some specific date (like ‘Last Trading Date’ or ‘Last Quotation Date’) that is used to identify the derivatives in the curve and uniquely place them on the x-axis. Normally, there is a countable set of the derivatives and their prices. They alone do not represent a curve, but just a set of tuples. As noted, in order to obtain a continuous curve, mathematical procedures like interpolation and/or extrapolation are used. It is noted that that price is just an approximation, since it is obtained via interpolation or extrapolation, but it is good enough for further calculations like the settling of prices or reevaluation of contracts.

### BRIEF DESCRIPTION OF THE DRAWINGS

FIG. 1 illustrates a derivative contract specification (DCS) template.

FIG. 2 illustrates a display interface for DCS key dates.

FIG. 3 illustrates a table of copper future data from the Chicago Mercantile Exchange.

FIG. 4 illustrates a price table of copper futures for the Market Identifier Code (MIC) of LME (London Metals Exchange).

FIG. 5 illustrates an initial user interface for a commodity curve based on DCS.

FIG. 6 illustrates a table of data from a Derivative Contract Specification (DCS) and from market data from an exchange.

FIG. 7 is a user interface that illustrates the quality of data that is used to construct a commodity curve based on DCS.

FIG. 8 illustrates a commodity curve based on DCS.

FIGS. 9A and 9B are a flow chart illustrating an example process of constructing a commodity curve based on DCS.

FIG. 10 is a block diagram of a computer system in connection with which embodiments of the present disclosure can operate.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

A first type of commodity curve is based on futures (future style curve or based on futures), a second type of commodity curve is based on forward rates (forward style curve or based on forward rates), and a third type of commodity curve is based on derivative contract specifications (DCS) (commodity curve based on DCS). The focus of this disclosure is the commodity curve based on DCS. Despite the fact that these curves have some things in common, they are still considered to be separate entities. System settings are illustrated by various screenshots.

A Commodity curve (or simply ‘curve’ hereinafter) involves master data settings of the particular commodity at hand. The commonality for all curves is that they are based on the commodity ID and the commodity curve type. Therefore, at the beginning, these two entities will be discussed as is necessary for the particular curve at issue.

The commodity curve type (CCT) is a user-defined identity (ID) for the commodity curve. A commodity involves master data that contains different attributes necessary for various usages in Commodity Management (CM). Commodities can be abstract commodities that define a whole family of commodities (like copper) and real commodities that are bound to a location, such as a particular commodity that originates from a particular country or geographic region.

Several attributes are used in connection with commodity curves. With the exception of a ‘Commodity Curve Category’, these attributes are changeable at any point of time. That may have an influence in the curve construction and on the data that are read from the curve. In an embodiment, commodity curve master data includes ‘Basic Data’ that contains ‘Basic Curve Data’, ‘Interpolation/Extrapolation’ and ‘Spot Data’. These attributes can be identical for any type of curve (future, forward, DCS). The attribute of CCurve Rate Type can have values of ‘Ask’, ‘Mid’ or ‘Bid’.

Some commodity prices are quoted in currency units. This could be for example, U.S. cents, British pence, or Euro cents. The reason for this is that prices are quoted for a low quantity of the commodity—e.g., for a pound of sugar—and the price per pound could be quite low (e.g., 12.345 U.S. cents per pound). This price is not referred to as 0.12345 U.S. dollar, but rather is referred to as a price of 12.345 cents. This enables an embodiment to show commodity curve values in this quotation currency unit and not in the currency itself. However, if market data are available in one currency (for example, U.S. dollars), another currency cannot be used in the curve (for example, EUR). In such a case, the system is unable to construct the curve and issues a corresponding error message.

The unit of measure is a curve unit of measure. The market data are provided in a certain unit of measure (for example, TO), but can be converted into the curve unit of measure (for example, KG). This conversion produces a scaling of the curve. If the units of measure from the curve and the market data table cannot be converted, a corresponding error message is issued during construction of the curve.

Interpolation logic is used to define how the points in the curve are connected. It applies a mathematical formula to calculate the values between two points. Possible values are Constant Forward Interpolation, Constant Backward Interpolation, Linear Interpolation, Monotone Convex Interpolation, and Cubic Spline Interpolation. Monotone convex interpolation is suitable only for commodity curves that are based on forward rates. Constant interpolation is the simplest interpolation method. For constant interpolation, no calculation takes place. Rather, the values are identical to the value of one of the grid points. The difference between constant forward interpolation and constant backward interpolation is that the value is taken from the right grid point in the case of the backward interpolation, while the value is taken from the left grid point in the case of forward interpolation.

The extrapolation logic defines how the curve behaves outside of the defined range. The curve is always built for a range (start date=curve date, end date=last available future). However, since it is a (partially) continuous curve, its values are calculated beyond that range using extrapolation.

A read procedure is used to define the availability of the market used for constructing the curve. The curve is always constructed for a particular date, and the market data for futures is read for that date. However, there are situations when, for a specific day, no or not all market data are provided and stored in the market data tables. This may be either because there is a bank holiday for a specific commodity exchange, or that on a normal business day not all traded contracts quotations are delivered by market data providers (because of missing market liquidity or other reasons). However, it is normal for there to be some deviations from that path because, for example, market data are not loaded every day in the system. With the read procedure, it is precisely defined, in terms of availability, how the data should be read. The read procedure includes A Read Directly option, wherein data from the market data can be read only with the curve date. The read procedure also includes a Read Back option, wherein older data can be read. Logic is applied to each grid point independently. Consequently, market data are retrieved for each grid point of the curve by reading back from the requested curve date until a market price is found. By this setting, market data observed at different dates (for the different grid points) may be taken into account to build the curve. For example, for a specific grid point, if no value is found for the requested curve date, the value of this grid point is taken from a previous day, while all other grid point values may be taken from the curve date day. The read procedure also includes a Read Back Directly option. The Read Back Directly option is used when the requested curve date is on a weekend or bank holiday (this can happen for month end valuations). Then the latest available market data (from Friday) is used instead, and missing grid points in these Friday market data are then interpolated. A Max Days Readback can be designated, that indicates the number of days to be used for the read-back logic. If a spot price type is used, the curve starts with the spot price type of the first future in the curve (the one that is closest to the curve date).

As can be gleaned from the above, several commodity curve types are needed. The attributes listed above have a significant influence on a curve. For example, depending on the interpolation logic used, different values can be obtained from the curve despite the fact that the prices of the futures that built the curve remain identical. On the other hand, some processes may require a very precise curve and will not allow any read back, while in another case older data can be tolerated and the read back process can be used for several days. Therefore, several commodity curve types are needed so that several different curves of the same commodity category can be defined for the same commodity. In an example, a specific curve for a copper commodity PIT1_COPPER 100 and curve type 001 is built. By these two attributes, the curve is uniquely generated If another curve is needed, but with a different read back, another commodity curve type would be needed in order to create a new curve. This set up is common for all curve categories.

In a graphical display of a commodity curve, the points on the graph show the futures, while the lines are interpolated values between them. A user can navigate to the table values of the curve, where the tuples can be found in a form (date, price on that date).

With the foregoing general discussion of commodity curves serving as a basis, an embodiment can be referred to as a contract style curve or a commodity curve based on DCS (Derivative Contract Specification). In order to create this curve, there are some prerequisites to be met. A derivative contract specification (DCS) should be customized. The DCS is a mapping of a commodity future (or listed option) contract specification from a particular exchange in a commodity system. It is used as a template for creating commodity futures. It is also used to capture market data in the system.

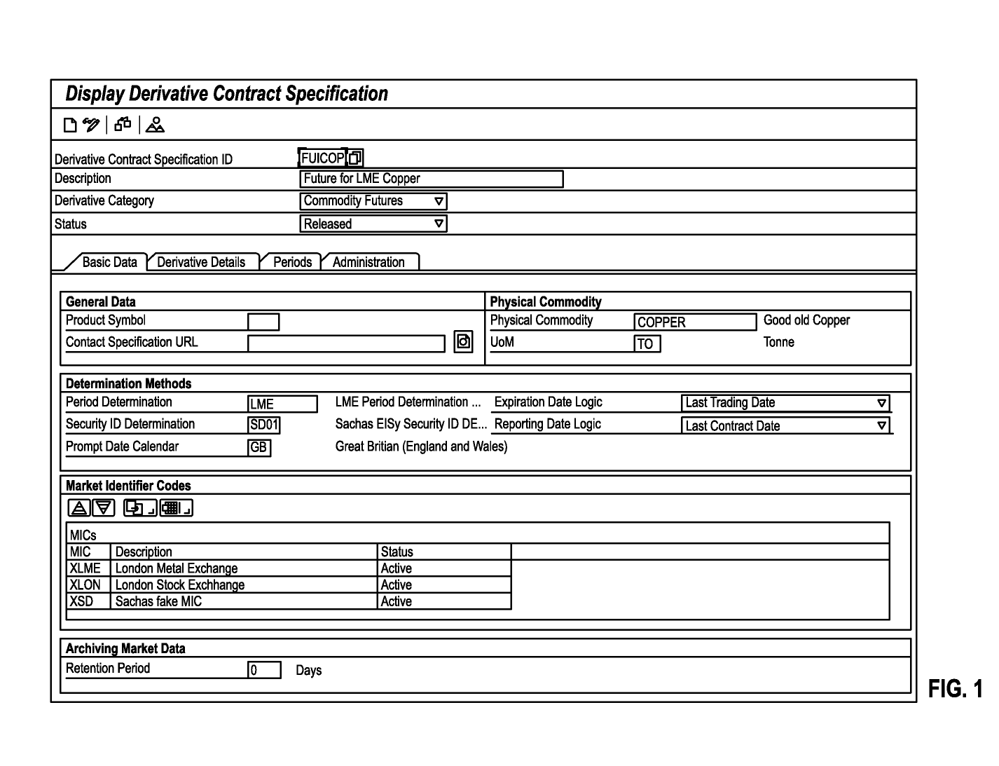

More specifically, the derivative contract specification (DCS) is a template (FIG. 1) that is used to capture contract specifications that are provided by an exchange. The DCS is a blueprint for financial contracts. Each derivative (that is, commodity future or listed option) is identified by a DCS ID and a key date.

The DCS carries all relevant information. Specifically, it includes capturing market data (either manually, via an Excel® upload, or a data feed). The DCS supplies default values when creating class data (future contracts), which is important to have when trading with futures. The DCS also constructs the actual commodity curve. The DCS can also perform pricing in a commodity price engine.

A derivative contract specification identifies the terms of the transaction. Depending on the type of derivative contract specification, it may include such information such as the underlying commodity, the grade of the underlying commodity, the product symbol, the market the derivative contract applies to, the hours of the market, the contract unit or lot size (e.g., the quantity of the commodity to be traded, the option to be purchased, and so forth), the currency units for price quotation (e.g., US dollars, US dollars and cents), clearable currencies (e.g., what currencies are acceptable for settling the contract), minimum price fluctuation per unit (e.g., the “tick size” or quantized change of price such as $10.00 US, $0.50 US, and so forth), the last trading day (e.g., last day for trading a particular contract), the settlement type (e.g, physical), location of settlement, delivery terms (location, time period, and so forth), and other information. A contract specification object may include data fields to capture some or all of this information. Some data in the derivative contract specification like contract size, or quotation unit of measure are time dependent, and can be changed by an exchange from time to time.

It should be noted that a derivative contract specification is particular to a given market or set of markets. Thus, the information in a particular derivative contract specification may not only depend on the type of derivative contract specification, but also on the commodity market and the underlying commodity. In accordance with this, the data fields of a particular contract specification object may vary somewhat by the commodity market, the type of derivative contract specification, the underlying commodity, or combinations thereof.

A given market has a plurality of derivative contract specifications for a plurality of commodities. A given derivative contract specification may apply to a plurality of markets. A given commodity may be traded according to a plurality of derivative contract specifications. Thus, a data model may account for these possibilities. A single physical commodity object may be associated with multiple contract specification objects a 1:n relationship link. A single contract specification object may be associated with multiple market identifier objects and a single market identifier object may be associated with multiple contract specification objects by an n:m relationship link.

Relationships between a physical commodity object, a contract specification object and a market identifier object may uniquely define a particular commodity traded at a particular market according to a particular derivative contract specification. Thus, such a combination may be used to track information about a particular commodity traded at a particular market according to a particular derivative contract specification, and then to construct a commodity curve based on DCS.

A market data management system may have different mechanisms to help enter and maintain information utilized in conjunction with a DCS data model. In some embodiments it may be desirable to employ automatic data entry. In such a situation, information may be retrieved from a network. For example derivative contract specifications for appropriate commodities may be retrieved from websites that publish derivative contract specifications of interest. In such embodiments, information may represent the derivative contract specifications. Information in such derivative contract specifications may be “scraped” or otherwise extracted in an automated fashion. For example, website pages containing appropriate derivative contract specifications maybe downloaded and the html associated with the webpage parsed to identify information of interest and the information of interest may be extracted.

Table 1 below may represent, for example, some information associated with a derivative contract specification for crude oil traded on the CME Globex market that may be obtained from a web page containing the appropriate derivative contract specification. The information is not meant to be exhaustive, simply illustrative, so actual derivative contracts may have either more or less information accordingly.

From this table (perhaps included in a web page), key information may be extracted, such as the commodity (crude oil), a description (light sweet crude oil), a product symbol (CL), a market (CME Globex), the contract unit (1,000 barrels), price quotation currency (dollars and cents per barrel), the “tic” size ($0.01 per barrel), special rules, such as limits on price fluctuation ($10.00 per barrel), the type of settlement (physical), and various delivery information. Such information may be placed in appropriate data objects of a data model.

By way of example, an appropriate physical commodity object may be created and appropriate fields such as a physical commodity name (crude oil), a physical commodity description (light sweet crude oil), and a physical commodity unit of measure (barrel) may be populated. An appropriate contract specification object may also be created and appropriate fields, such as the underlying commodity (crude oil), the grade of the underlying commodity (light sweet crude oil), the product symbol (CL), the market the derivative contract applies to (CME Globex), the lot size (1,000 barrels), the currency units for price quotation (US dollars and cents), tic size ($0.01 per barrel), the settlement type (physical), delivery terms (location, time period, and so forth) may be populated. Note that fields such as the underlying commodity and commodity grade may not reside in a contract specification object, but may be part of a physical commodity object and a link may be established between the two objects to define that information.

TABLE 1
Light Sweet Crude Oil Futures

| | |
|---|---|
| Product Symbol | CL |
| Venue | CME Globex, CME ClearPort, Open Outcry (New York) |
| Contract Unit | 1,000 barrels |
| Price Quotation | U.S. Dollars and Cents per barrel |
| Minimum | $0.01per barrel |
| Fluctuation | |
| Maximum Daily | Initial Price Fluctuation Limits for All Contract Months. At the |
| Price Fluctuation | commencement of each trading day, there shall be price |
| | fluctuation limits in effect for each contract month of this futures |
| | contract of $10.00 per barrel above or below the previous day's |
| | settlement price for such contract month. If a market for any of |
| | the first three (3) contract months is bid or offered at the upper or |
| | lower price fluctuation limit, as applicable, on Globex it will be |
| | considered a Triggering Event which will halt trading for a five |
| | (5) minute period in all contract months of the CL futures |
| | contract, as well as all contract months in all products cited in the |
| | Associated Products Appendix of rule 200.06. Trading in any |
| | option related to this contract or in an option contract related to |
| | any products cited in the Associated Products Appendix which |
| | may be available for trading on either Globex or on the Trading Floor |
| | shall additionally be subject to a coordinated trading halt. |
| Settlement Type | Physical |
| Delivery | Delivery shall be made free-on-board (“F.O.B.”) at any pipeline |
| | or storage facility in Cushing, Oklahoma with pipeline access to |
| | Enterprise, Cushing storage or Enbridge, Cushing storage. |
| | Delivery shall be made in accordance with all applicable Federal |
| | executive orders and all applicable Federal, State and local laws and |
| | regulations. |
| | At buyer's option, delivery shall be made by any of the following |
| | methods: (1) by interfacility transfer (“pumpover”) into a |
| | designated pipeline or storage facility with access to seller's |
| | incoming pipeline or storage facility; (2) by in-line (or in-system) |
| | transfer, or book-out of title to the buyer; or (3) if the seller |
| | agrees to such transfer and if the facility used by the seller allows |
| | for such transfer, without physical movement of product, by in- |
| | tank transfer of title to the buyer. |
| Delivery Period | (A) Delivery shall take place no earlier than the first calendar day |
| | of the delivery month and no later than the last calendar day of |
| | the delivery month. |
| | (B) It is the short's obligation to ensure that its crude oil receipts, |
| | including each specific foreign crude oil stream, if applicable, are |
| | available to begin flowing ratably in Cushing, Oklahoma by the |
| | first day of the delivery month, in accord with generally accepted |
| | pipeline scheduling practices. |
| | (C) Transfer of title-The seller shall give the buyer pipeline |
| | ticket, any other quantitative certificates and all appropriate |
| | documents upon receipt of payment. |

Thus, by obtaining information such as derivative contract specifications from a network, the information may be parsed and appropriate data objects may be created and fields in those data objects populated in an automated fashion.

Rather than automatically creating and populating appropriate data objects, information may be entered from the retrieved information through an appropriate user interface. An appropriate user interface may take a variety of forms, but such an interface may typically have a plurality of regions where information may be displayed, entered, and/or combinations thereof. As information is entered, appropriate data objects may be created and fields populated. To the extent that information already exists in the system, it need not be reentered, simply retrieved and/or linked to. As an example, if a market identifier object has already been crated for CME Globex, the object may simply be linked to in an appropriate manner.

Combinations of the automatic creation/population and user interface approaches may also be used. As an example, if an appropriate physical commodity object and a market identifier object already exist, and if a derivative contract specification for the commodity described in physical commodity object from the market described in a market identifier object is retrieved as information, and if parsing the retrieved information identified the commodity associated with the physical commodity object and the market associated with market identifier object, the information in these objects may be retrieved and placed in the appropriate locations in a user interface to “pre-populate” the user interface with information that already exists in the system. Furthermore, other information retrieved from the derivative contract specification may be populated into the user interface to aid in entry of the appropriate information.

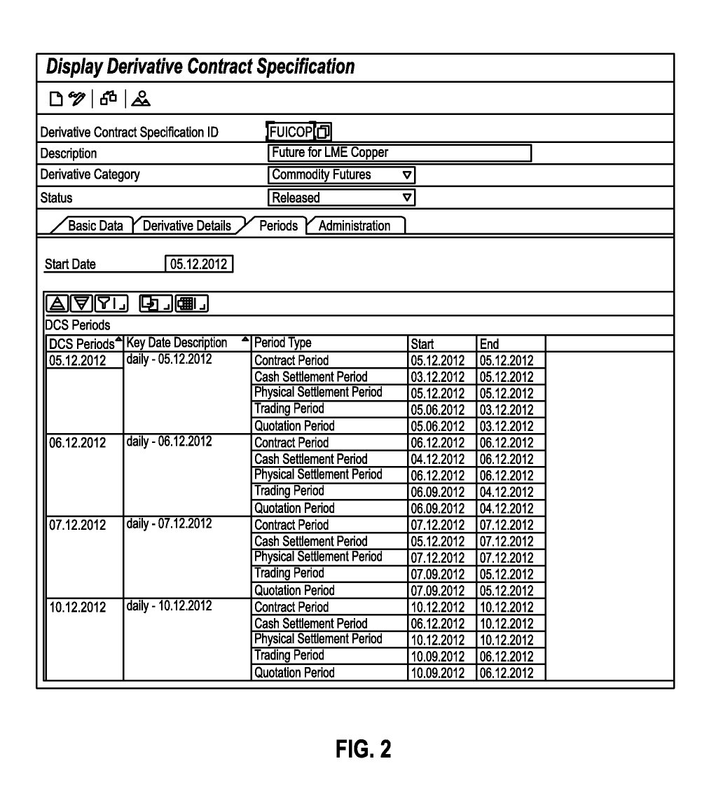

FIG. 2 represents an example table that may be displayed on a user interface. The fields of FIG. 2 Table 2 include a key date, a description of the key date, what type of period it is, when the start and end dates of the period are. Note that these fields may be calculated or determined from information entered elsewhere. A key date is a date in combination with a derivative contract specification that identifies, for example, individual futures with a defined last trading and settlement date in a market. Each exchange may have its way of calculating these type of period dates. It may also be that different commodities may influence the dates and the way the dates are calculated. It may further be that a derivative contract specification may influence the dates and the way the dates are calculated. Thus, entered information relating to period determination methods may be used to select logic to calculate some or all of the information in FIG. 2.

Pricing information may be extracted by a price extraction module adapted to take in a data feed and extract from the data feed information that corresponds with the physical commodity objects, contract specification objects, and market identifier objects active in the system. As previously mentioned, the combination of a commodity, a market and a derivative contract specification uniquely specifies the terms and price of a commodity. Thus, the relationships between commodities represented in physical commodity objects, the markets represented in market identifier objects and the derivative contract specifications represented in contract specification objects identify the information that should be extracted from a data feed. Pricing information about the commodity may be extracted from a data feed and the information captured in an appropriate data object or combination of data objects. The price may be captured as part of an existing object (e.g a commodity object, a market identifier object, a contract specification object, and/or combinations thereof), or the price may be captured as part of a separate pricing object and relationships between other objects may be made. In one example, the pricing object may have a 1:1 relationship with a combination of a physical commodity object, a contract specification object and a market identifier object.

As an alternative to capturing information from a data feed or manual data entry, a market data management system may import pricing information from a document containing pricing information. For example, all the appropriate information may be collected into a spreadsheet and the spreadsheet document imported into the system.

An embodiment uses a key date. The key date, in combination with the derivative contract specification (DCS), identifies individual futures with a defined last trading date and settlement date in the market. Since these derivatives are forward transactions, they are defined not only by a contract specification (DCS) but also by a unique time identifier. Commonly, the futures are referred to with a time reference, such as “Daily LME Copper future that prompts on 21.06.2013”, or “June 2013 CME Copper Future”. In a DCS-related infrastructure, the time component of the future is defined by the key date. It is a date that, in combination with DCS, uniquely defines the future. As an example, the DCS ID is equal to T2_CU and the key date is equal to 21.06.2013, and this defines “Daily LME Copper future that prompts on 21.06.2013”. As another example, the DCS ID is equal to T2_HG and the key date is equal to 26.06.2013, and this defines “June 2013 CME Copper Future”. Key Dates are determined either automatically by the system or they can be manually entered into the system.

The example in FIG. 1 illustrates some features that are used in constructing the commodity curve based on DCS using as an example the commodity copper future from LME (London Metal Exchange). In FIG. 1, ‘LME’ in the Period Determination field indicates that the futures are automatically determined according to the specific logic of the LME. The LME issues and handles, for various commodities, a large number of daily, weekly, and monthly futures. For example, for copper, daily futures are handled for the upcoming months (for example, for the upcoming next three months), the following three months of weekly futures, and then for the next 12 months of monthly futures. In the setup of DCS, the futures are uniquely identified via ‘Key Date’ in combination with DCS (from the LME). Despite the fact that ‘Key Date’ is technically a date, it does not have the semantics of a date. Rather, the ‘Key date’ together with DCS can be thought as of any security identifier like PITCA_NOV12′. Similarly, as defined for single futures, one DCS-based future should have some real time frame, for example, the period when it is traded or the period when the quotations are published. The ‘Expiration Date Logic’ in FIG. 1 from the DCS defines by which real date the future is to be identified in a time frame. LME determination logic provides not just a ‘Key Date’ of the future, but also calculates all of its real time periods like trading period, quotation period, cash settlement period, physical settlement period, and contract period. A Contract period defines a period of the future. For dailies it is one day, for weeklies it is one week, and for monthlies it is one month. The LME ‘Expiration Date Logic’ provides a unique determination of the futures in a time slot. For example, the future with ‘Key Date’ 05.12.2012 (once again, this is not a date, but an identifier) will be identified in a real time by its ‘Last Trading Date’ of 03.12.2012 (See FIG. 2).

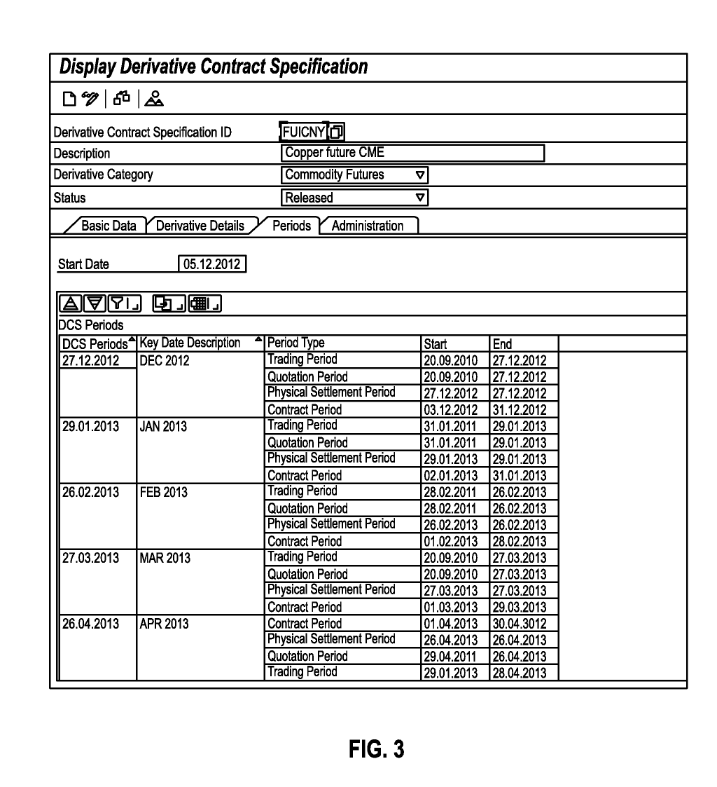

Referring to FIG. 3, which illustrates another example for copper using the CME (Chicago Mercantile Exchange), the CME indicates that the futures are issued and handled less frequently than they are issued and handled by the LME. Since the CME issues monthly futures for copper, the system refers to ‘November 2012 Copper Future’ or ‘January 2013 Copper Future’. Following the DCS logic that futures are identified by their ‘Key Date’ for the monthly futures, a ‘Key Date’ is determined. For the DCS (FUTCNY) in FIG. 3, the CME Copper Period Determination Logic is used and according to this logic, only monthly futures are available. In this way, December 2012 copper futures are identified by the ‘Key Date’ 27.12.2012, but in a real time frame it is defined by its ‘Last Trading Date’ that is by chance in the example of FIG. 3 also 27.12.2012.

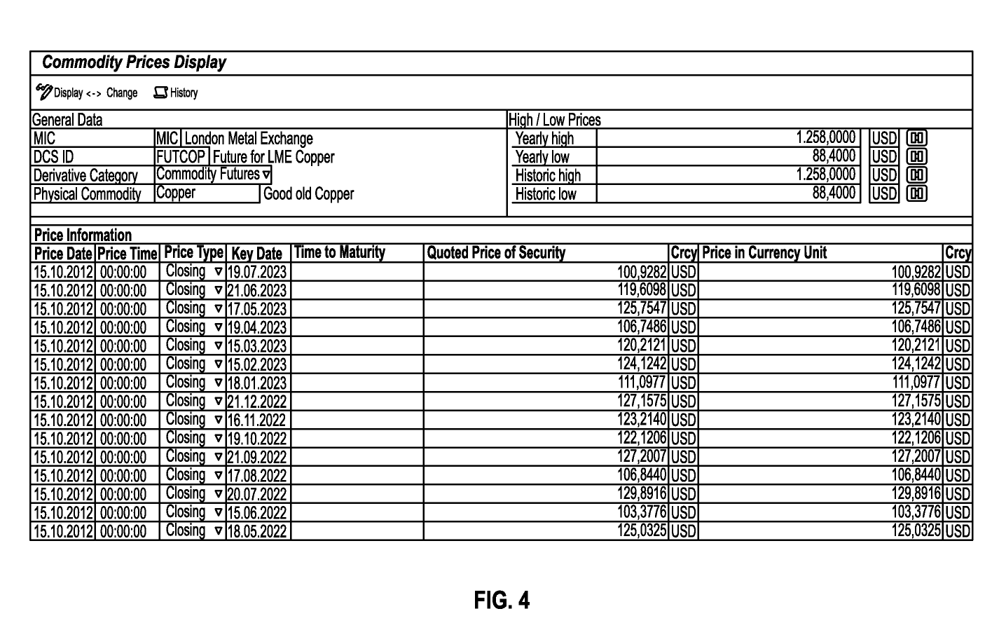

A second precondition for a commodity curve based on DCS is that market data are available in the system for the combination of DCS/MIC (FUTCOP/LME), that is, copper futures on the London Metals Exchange as indicated in FIG. 4. Market data are normally published by the exchange (LME, CME, etc.) and can be either uploaded into the system via data feed, an Excel® upload, or manually entered. In an example, a large amount of data can be available (around 200 copper futures are handled on the LME every single day), and the data feed is a preferable option. However, there are commodities where the exchanges issue a relatively small number of futures, like in the case of agricultural commodities. In the case of agricultural commodities, the data can be entered manually via a transaction program or module.

To create a commodity curve based on DCS, the creation is initiated via a user interface. From a drop down menu, ‘Based on DCS’ is chosen for the Commodity Curve Category.

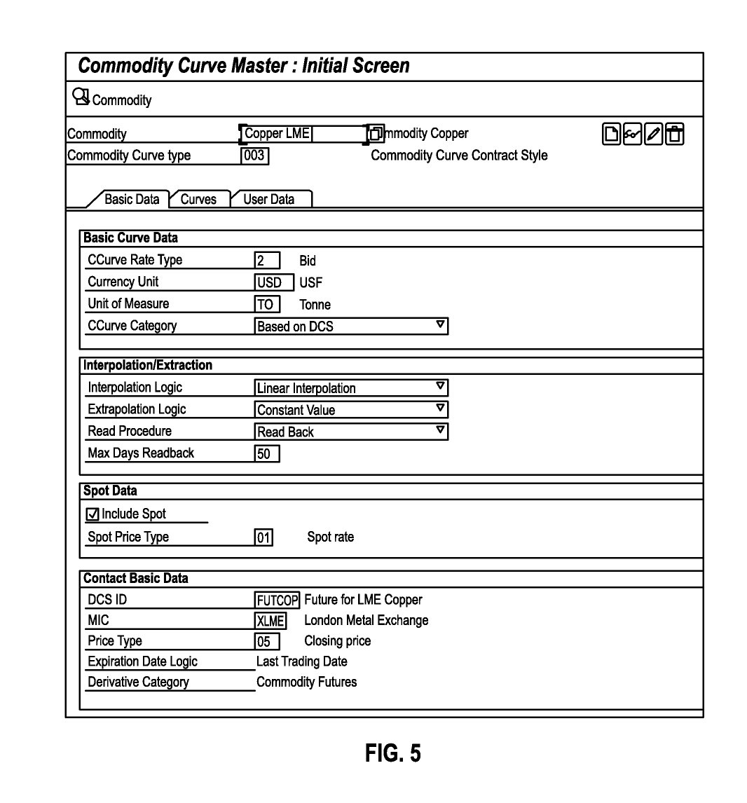

The initial user interface for the commodity curve based on DCS is illustrated in FIG. 5. For the commodity curve based on DCS, the difference in the ‘Basic Data’ tab is in the section ‘Contract Basic Data’, where it is set to a combination of DCS and MIC (e.g., LME), which in turn defines the curve. DCS ID identifies the derivative contract specification that will serve as a source of available futures. MIC is the market identifier code, which together with DCS, determines the prices of the futures. Price Type defines with which prices a curve is defined (that is, for example, Spot, Opening, Bid, Mid, Ask, Closing). It is noteworthy that Security Price Type is a customizing entity. Customers define their own Price Types. Commonly the Price Types are defined as ‘Spot’, ‘Ask’, ‘Mid’, etc., but it is left to the customers to decide. This means that Price Types can be called whatever a customer wants. Expiration Date Logic is a read only field, which is taken from the DCS, and which points out how the futures are going to be identified in a time frame. The Derivative Category is also a read only field, and it points out what is a category of the DCS (as far as distinguished between ‘Commodity Futures’ and ‘Listed Options’). The combination of the MIC and DCS must be valid. The spot check box, in the ‘Spot Data’ section for the DCS-based curve, is completely based on the DCS/MIC data. That is, spot means that the curve starts with ‘Spot Price Type’ of the first future in the curve (the one that is closest to the curve date).

It is possible to construct a commodity curve based on DCS for some commodity based on the DCS and market data of another commodity. This is a unique and desirable feature. An example is the commodity bitumen, whose price can be based on oil, because bitumen is not exchange traded. In such situations, the DCS is defined for oil, and the prices are entered for that DCS/MIC combination, and a curve is defined for the commodity bitumen. In an embodiment, the user receives a warning that the commodity and the combination of DCS/MIC do not match, but this mismatch is not incorrect, either technically or from the business perspective. The tab ‘Curves’ in FIG. 5 shows the quality of the data that construct a curve for a given quotation date range. To display a commodity curve based on DCS, a user clicks on the quotation date and that leads to the display of the grid points and graphical presentation of the commodity curve based on DCS (using the exchange-provided future data and using the data from the exchange and the curve details such as interpolation and extraction techniques provided via the interface of FIG. 5).

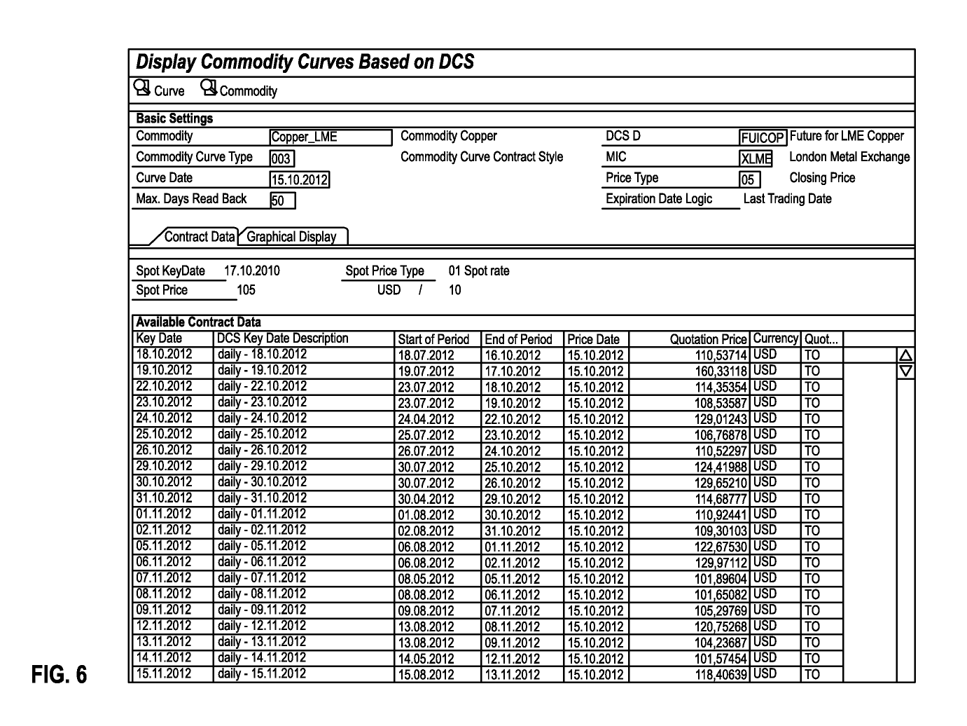

FIG. 6 is a table of data from the DCS and the exchange that are used for the creation of a commodity curve based on DCS. In order to understand how the data are selected, once again, the ‘Expiration Date Logic’ and the x-axis of the commodity curve are considered. On the x-axis of the commodity curve, all futures are available on the ‘Curve Date’ according to the ‘Expiration Date Logic’, sorted in descending order from the ‘Curve Date’ through infinity (31.12.9999). At the ‘Curve Date’, all futures are selected (here presented by its identifier ‘Key Date’ and the corresponding ‘Key Date Description’), whose ‘Last Trading Date’ (this is ‘Expiration Date Logic’ for the underlying DCS FUTCOP) is greater than or equal to the curve date. For that set of futures, the market data prices are read from the new market data table and then displayed as ‘Quotation Price’ together with currency and Quotation Unit of Measure. Since in this example it was chosen that the curve starts with spot, the first future is then selected that goes in the curve and its price is read according to the ‘Spot Price Type’. These dates are displayed above ‘Available Contract Data’.

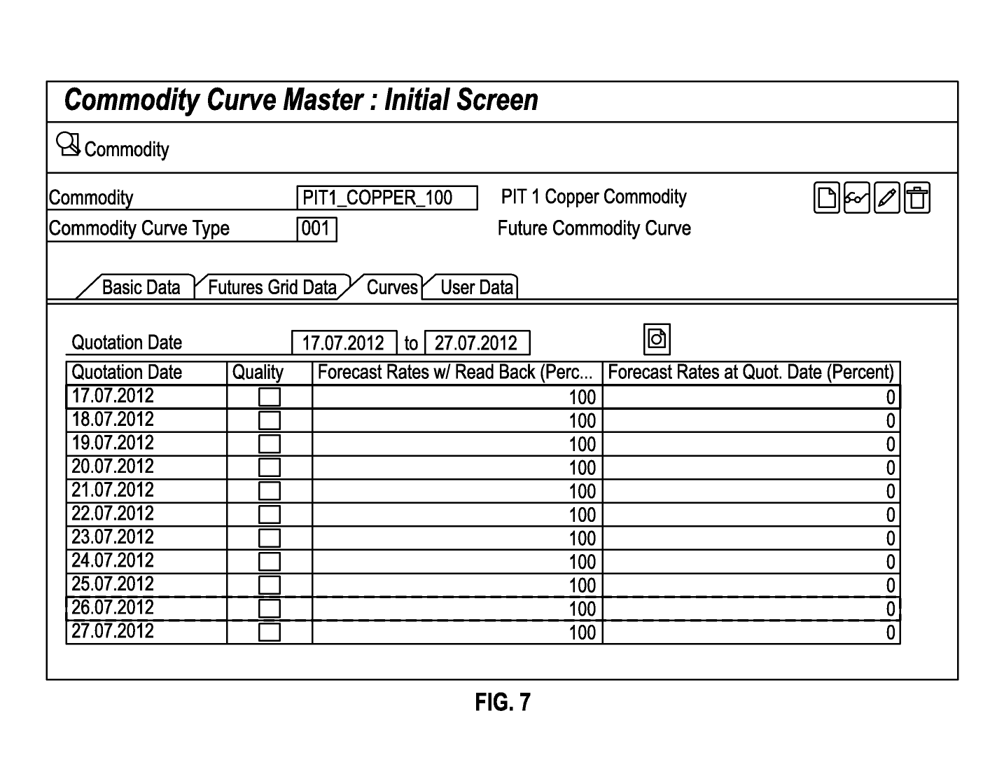

FIG. 7 illustrates, for a particular time period (for example, the last 10 days looking back from the system date), the quality of the data that built the curve. For example, as illustrated in FIG. 7, for the quotation date 17.07.2012, all prices are known for all futures that are in the curve on that date. This is expressed via the percentage value 100 in the column ‘Forecast Rates w/ Read Back (Perc.)’. Also, all prices are found on that date precisely that gives another 100% of ‘Forecast Rates at Quot. Date (Percent)’. For the quotation date 26.07.2012, all prices are also known for all futures, but they are obtained via the read back procedure. This information comes from the column ‘Forecast Rates at Quot. Date (Percent)’ that has value 0, meaning that on that day no price for any future was available. The tab ‘User data’ in FIG. 7 contains the administrative data about user and time point when the curve master data was created or changed. In an embodiment, a user can display a curve in graphical form by clicking on a button. The button can be labeled as the ‘Quotation Date’. The construction of the curve will be based on the configuration of the DCS (for example, interpolation and extrapolation methods) and the MIC and the data associated therewith.

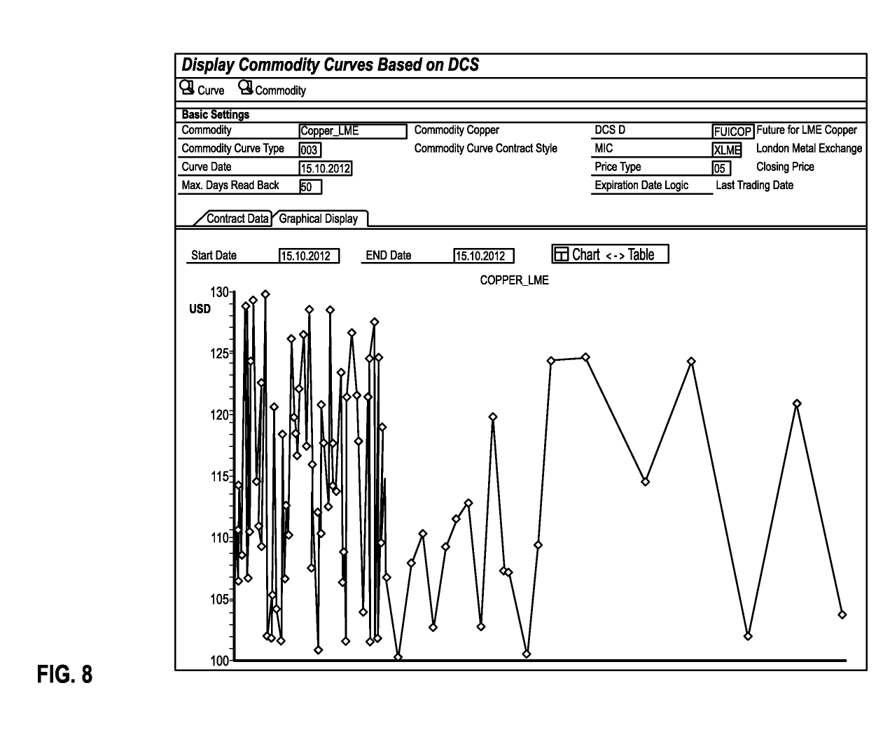

As illustrated in FIG. 8, the ‘Graphical Display’ of the curve generates a very dense curve in terms of density of the original market data. While such a commodity curve based on DCS may be similar to a futures curve, it is unimaginable that in generating a future curve all available futures for everyday will be created and their prices entered in the system by a user. Therefore, an advantage of the commodity curve based on DCS is quite apparent. That is, the market data from the exchange for a commodity are there to be read. For the commodity curve based on DCS, the DCS and MIC (one time activity) are customized, and the data is uploaded into the system (via a data feed), and the curve is defined (one time activity as well). With the DCS and the exchange market data, the system creates the curve.

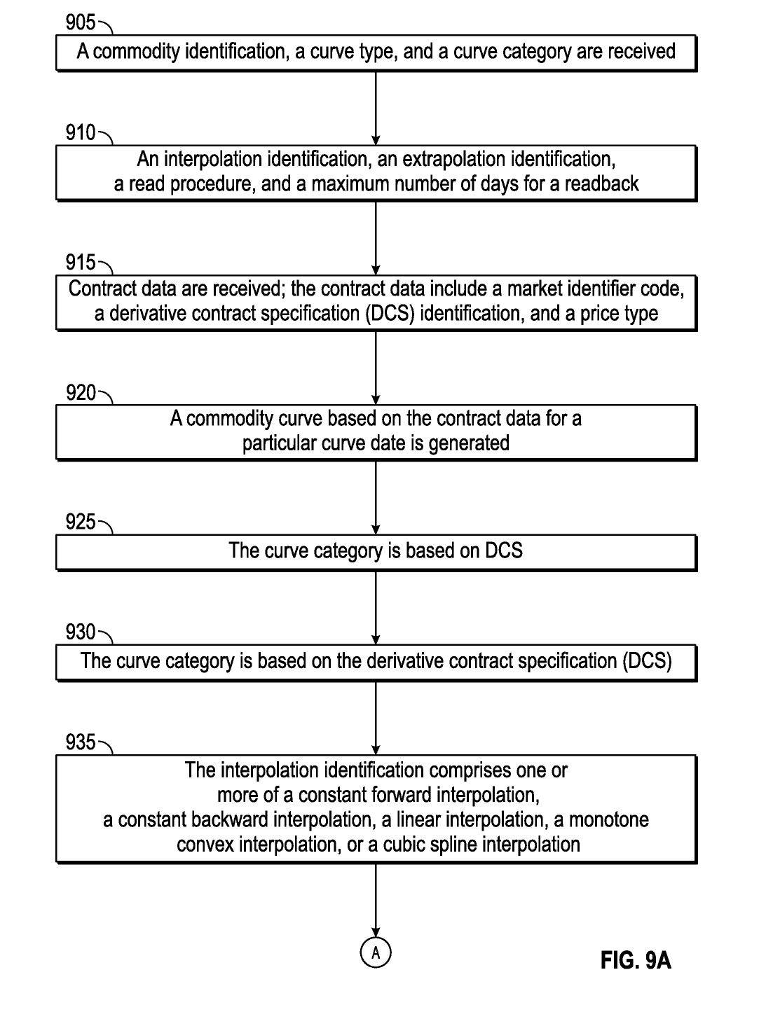

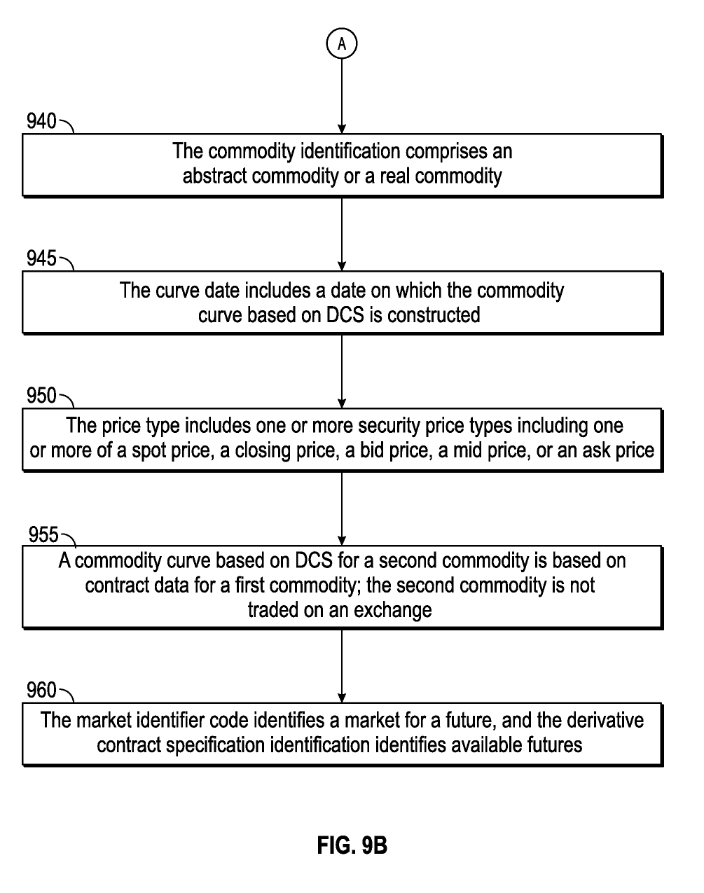

FIGS. 9A and 9B are a block diagram illustrating operations and features of a system for creating a commodity curve based on DCS. FIGS. 9A and 9B include a number of operation and process blocks 905-960. Though arranged serially in the example of FIGS. 9A and 9B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 9A and 9B, at 905, a commodity identification, a curve type, and a curve category are received into a computer processor. The commodity identification identifies that commodity such as copper, gold, or sugar. The curve type identifies the type of curve such as a commodity curve based on DCS. And the curve category is used to identify different curves for the same commodity and the same data, but which uses a different feature within the DCS, such as a different Read procedure or a different extrapolation method. At 910, an interpolation identification, an extrapolation identification, and a read procedure are received into the computer processor. The extrapolation interpretation can include for example constant or linear extrapolation. As noted above, the read procedure can include one or more of a Read Directly option, a Read Back option, and a Read Back Directly option. It also shall include Max Days Readback (with this parameter it is determined how many days are used for the read back). It also shall include Max Days Readback (with this parameter we determine how many days we use for the read back) At 915, contract data are received into the computer processor. The contract data include a market identifier code (e.g., the LME), a derivative contract specification (DCS) identification, and a price type. As noted, the DCS ID is a template that identifies a particular commodity, from a particular exchange, and dates for use in retrieving data from that exchange and constructing the curve. The data retrieval using the DCS is automatic, not manual. At 920, the computer processor uses the contract data to generate a commodity curve based on DCS for a particular curve date. At 925, the computer processor displays the commodity curve based on DCS on an electronic display unit.

At 930, the curve category is based on the derivative contract specification (DCS). At 935, the interpolation identification comprises one or more of a constant forward interpolation, a constant backward interpolation, a linear interpolation, a monotone convex interpolation, or a cubic spline interpolation. Constant interpolation is the simplest interpolation method. For constant interpolation, no calculation takes place. Rather, the values are identical to the value of one of the grid points. The difference between constant forward interpolation and constant backward interpolation is that the value is taken from the right grid point in the case of the backward interpolation, while the value is taken from the left grid point in the case of forward interpolation. That is, the price from the left is forwarded until the next one is available. Linear interpolation involves the simple drawing of a straight line between two points. Monotone convex interpolation is suitable only for commodity curves that are based on forward. As known to those of skill in the art, monotone convex interpolation involves a piecewise quadratic spline interpolation that can be used for rates defined on an interval rather than a single point, since the curve averages to the rates for each interval. It is guaranteed to be locally monotone and convex if the inputs show the analogous discrete properties. Cubic spline interpolation, like monotone convex interpolation, is known to those of skill in the art. With cubic spline interpolation, third-degree polynomials are used for the interpolation. The advantage of this procedure in comparison with linear interpolation is that, instead of having a constant curve, continuous differentiation is possible, resulting in a “smoother” curve. Another characteristic is that, when the initial data is monotone (such as a rising commodity curve), the resulting curve is also monotone. At 940, the commodity identification comprises an abstract commodity (whole family of commodities like copper) or a real commodity (bounded to a location). An abstract commodity can include an aggregation of a whole family of commodities, such as a family of copper commodities. A real commodity is bounded to a particular location, such as a particular country, group of countries, or geographic region. At 945, the curve date includes a date on which the commodity curve based on DCS is constructed. At 950, the price type includes one or more security price types including one or more of a spot price, a closing price, a bid price, a mid price, or an ask price. At 955, a commodity curve based on DCS for a second commodity is based on a contract price, a contract curve, or contract data for a first commodity, wherein the second commodity is not traded on an exchange. This feature allows the construction of contract curves based on DCS for commodities for which market data is not readily available. At 960, the market identifier code identifies a market for a future (such as the LME), and the derivative contract specification identification identifies available futures.

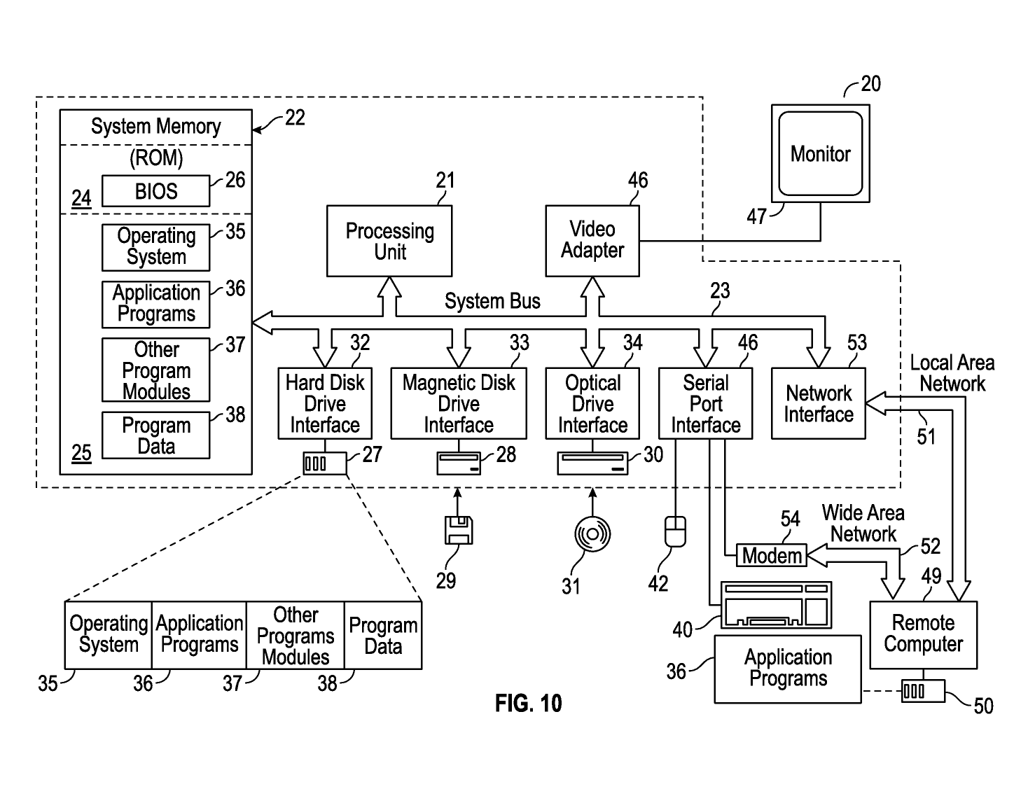

FIG. 10 is an overview diagram of hardware and operating environment in conjunction with which embodiments of the invention may be practiced. The description of FIG. 10 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 10, a hardware and operating environment is provided that is applicable to any of the servers and/or remote clients shown in the other Figures.

As shown in FIG. 10, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 10 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

1. A system comprising:
a computer processor operable to:
receive a commodity identification, a curve type, and a curve category;
receive an interpolation identification, an extrapolation identification, a read procedure, and a maximum number of days for a readback;
receive contract data, the contract data comprising a market identifier code, a derivative contract specification (DCS) identification, and a price type;
use the contract data to generate a commodity curve based on DCS for a curve date; and
display the commodity curve based on DCS on an electronic display unit.

2. The system of claim 1, wherein the curve category is based on the derivative contract specifications (DCS).

3. The system of claim 1, wherein the interpolation identification comprises one or more of a constant forward interpolation, a constant backward interpolation, a linear interpolation, a monotone convex interpolation, or a cubic spline interpolation.

4. The system of claim 1, wherein the commodity identification comprises an abstract commodity (whole family of commodities like copper) or a real commodity (bounded to a location).

5. The system of claim 1, wherein the curve date comprises a date on which the commodity curve based on DCS is constructed.

6. The system of claim 1, wherein the price type comprises one or more security price types including one or more of a spot price, a closing price, a bid price, a mid price, or an ask price.

7. The system of claim 1, wherein a commodity curve based on DCS for a second commodity is based on contract data for a first commodity, and wherein the second commodity is not traded on an exchange.

8. The system of claim 1, wherein the market identifier code identifies a market for a future, and the derivative contract specification identification identifies available futures.

9. A process comprising:
receiving a commodity identification, a curve type, and a curve category;
receiving an interpolation identification, an extrapolation identification, a read procedure, and a maximum number of days for a readback;
receiving contract data, the contract data comprising a market identifier code, a derivative contract specification (DCS) identification, and a price type;
using the contract data to generate a commodity curve based on DCS for a particular curve date; and
displaying the commodity curve based on DCS on an electronic display unit.

10. The process of claim 9, wherein the curve category is based on the derivative contract specifications (DCS).

11. The process of claim 9, wherein the interpolation identification comprises one or more of a constant forward interpolation, a constant backward interpolation, a linear interpolation, a monotone convex interpolation, or a cubic spline interpolation.

12. The process of claim 9, wherein the commodity identification comprises an abstract commodity (whole family of commodities like copper) or a real commodity (bounded to a location).

13. The process of claim 9, wherein the curve date comprises a date on which the commodity curve based on DCS is constructed.

14. The process of claim 9, wherein the price type comprises one or more security price types including one or more of a spot price, a closing price, a bid price, a mid price, or an ask price.

15. The process of claim 9, wherein a commodity curve based on DCS for a second commodity is based on contract data for a first commodity, and wherein the second commodity is not traded on an exchange.

16. The process of claim 9, wherein the market identifier code identifies a market for a future, and the derivative contract specification identification identifies available futures.

17. A computer readable medium comprising instructions that when executed by a processor execute a process comprising:
receiving a commodity identification, a curve type, and a curve category;
receiving an interpolation identification, an extrapolation identification, a read procedure, and a maximum number of days for a readback;
receiving contract data, the contract data comprising a market identifier code, a derivative contract specification (DCS) identification, and a price type;
using the contract data to generate a commodity curve based on DCS for a particular curve date; and
displaying the commodity curve based on DCS on an electronic display unit.

18. The computer readable medium of claim 17, wherein the interpolation identification comprises one or more of a constant forward interpolation, a constant backward interpolation, a linear interpolation, a monotone convex interpolation, or a cubic spline interpolation.

19. The computer readable medium of claim 17, wherein the price type comprises one or more security price types including one or more of a spot price, a closing price, a bid price, a mid price, or an ask price.

20. The computer readable medium of claim 17, wherein a commodity curve based on DCS for a second commodity is based on contract data for a first commodity, and wherein the second commodity is not traded on an exchange.
